(19) United States
(12) Patent Application Publication
(10) Pub. No.: US 2006/0158991 A1
(43) Pub. Date: Jul. 20, 2006

(54) Reflective optical element and optical pickup including the same

(75) Inventors: Takuji Hatano, Osaka (JP); Hiroshi Hirayama, Tokyo (JP); Miyuki Teramoto, Osaka (JP)

Correspondence Address: Jason M. Wejnert, P.O. Box 10395, Chicago, IL, 60610, US

(73) Assignee: Konica-Minolta Opto, Inc, Tokyo (JP)

(21) Appl. No.: 11/316,366

(22) Filed: Dec. 22, 2005

(30) Foreign Application Priority Data
Dec. 27, 2004 (JP) JP2004-375895

(51) Int. Cl. G11B 7/135

(52) U.S. Cl. 369/112.01

(57) ABSTRACT

A rising mirror is constructed by forming on a glass substrate a first region and a second region having different reflection properties. The first region is formed of, for example, an antireflection film, and the second regions is formed by superimposing a phase adjustment layer for adjusting the phase of reflected light and a dielectric multilayer film in this order. Forming the phase adjustment layer on the glass substrate in this manner permits, for example, phase adjustment such as eliminates phase shift in reflected light between the regions, and phase adjustment such as cancels out phase shift caused by the objective lens of the optical disc, thereby permitting suppressing disturbance in the wave front of reflected light as whole.

This application is based on Japanese Patent Application No. 2004-0375895 filed on Dec. 27, 2004, the contents of which are hereby incorporated by reference.

### BACKGROUND OF THE INVENTION

1. Field of the Invention

The present invention relates to a reflective optical element which is arranged in the optical path, for example, between a light source and an objective lens and which reflects light from the light source and thereby directs the light to the objective lens, and to an optical pickup including the reflective optical element.

2. Description of the Prior Art

Optical pickups have been conventionally proposed which employ a variable aperture separation filter for varying the NA (numerical aperture) of an objective lens in accordance with the wavelength. For example, Japanese Patent Application Laid-open No. H11-328715 discloses an optical pickup that employs a variable aperture separation filter having a filter film 102 and a phase adjustment film 103 formed on a glass substrate 101, as shown in FIG. 23.

The filter film 102 transmits light having a wavelength of 655 nm and reflects light having a wavelength of 790 nm, and is formed, as shown in FIG. 24, just around the outer periphery of a small circular region A whose diameter is smaller than an effectgive diameter B of the objective lens. The phase control film 103 transmits both light having a wavelength of 655 nm and light having a wavelength of 790 nm, and is formed in the circular region A.

With this structure, light having a wavelength of 655 nm is transmitted through both the outside and inside of the circular region A of the variable aperture separation filter; therefore, the NA corresponding to the light having a wavelength of 655 nm is determined by the effective diameter B of the objective lens. On the other hand, light having a wavelength of 790 nm is transmitted through only the inside of the circular region A; therefore, the effective NA corresponding to the light having a wavelength of 790 nm is determined by the diameter of the circular region A. Thus, the use of such a variable aperture separation filter permits recording and reproduction to be performed on a plurality kinds of optical discs (for example, a DVD and a CD) with the same optical pickup.

In the variable aperture separation filter described above, the filter film 102 and the phase control film 103 are composed of a plurality of layers. It is believed that appropriate selection of material for each of the layers and the layer structure permits adjusting properties (phase) of transmitted light, thereby preventing disturbance in the wave front of the transmitted light.

In the fields of optical pickups and printers, a so-called front monitoring method has been widely used in recent years, in which method some of light emitted forward (for example, toward an objective lens) from a light source are branched at a predetermined position of the optical system so as to be used as monitored light so that the amount of light emission from the light source is stabilized based on the monitored light. Such a front monitoring method can be achieved by, for example, arranging in front of an objective lens, a reflective optical element (for example, a rising mirror) which has on the same plane a plurality of regions having different reflection properties. More specifically, with this construction, of light emitted from the light source, the light obtained via an arbitrary region of the reflective optical element can be used as monitored light while the light obtained via the entire region thereof can be shined on an optical disk via the objective lens.

However, when such a reflective optical element is used, phase shift occurs in reflected light between the plurality of regions having different reflection properties. This, combined with phase shift attributable to the objective lens, causes a problem of disturbance in the wave front of light shined on the optical disc. Disturbance in the wave front of transmitted light would be prevented with the construction disclosed in the publication described above. However, no method has yet been established for preventing disturbance in the wave front of reflected light.

### SUMMARY OF THE INVENTION

In view of the problem described above, the present invention has been made, and it is an object of the invention to provide a reflective optical element capable of suppressing disturbance in the wave front of light reflected on a plurality of regions having different reflection properties, and to an optical pickup including the reflective optical element.

To achieve the object described above, according to one aspect of the invention, a reflective optical element includes a plurality of regions formed on the same plane (on the same substrate) and having different reflection properties, and at least one of the plurality of regions has a phase adjustment layer for adjusting the phase of reflected light.

According to the configuration described above, the plurality of regions having different reflection properties are formed on the same plane. Thus, when this reflective optical element is applied to, for example, a rising mirror of an optical pickup, of light emitted from the light source, the light transmitted at a predetermined transmittance through an arbitrary region of the reflective optical element can be used as monitored light for adjusting the mount of light from the light source while the light reflected on the entire region of the reflective optical element can be shined on an optical disc via an objective lens. That is, a front monitoring method can be achieved in which monitored light is obtained ahead of the light source (on the objective lens side).

Moreover, with the configuration described above, at least one of the plurality of regions having different reflection properties in the reflective optical element has the phase adjustment layer, by which the phase of reflected light on a corresponding region is adjusted. In this case, possible phase adjustment includes, for example, adjustment such as eliminates phase shift in reflected light between the regions, and phase adjustment such as cancels out phase shift caused by the objective lens of the optical pickup (that causes phase shift in this case). Therefore, providing the reflective optical element with the phase adjustment layer permits suppressing disturbance in the wave front of reflected light as a whole obtained via the plurality of regions having different reflection properties.

The reflective optical element of the invention, when using light reflected on the plurality of regions having different reflection properties, is applicable not only to the rising mirror of the optical pickup, but also to, for example, a bending mirror of a laser printer.

According to another aspect of the invention, an optical pickup includes a light source that emits light, and a rising mirror that reflects the light emitted from the light source and directs the light to an optical disc. The rising mirror is composed of the reflective optical element of the present invention described above.

According to the configuration described above, light emitted from the light source is directed to the optical disc via the rising mirror. In this case, since the rising mirror is composed of the reflective optical element of the invention, disturbance in the wave front of light reflected on the rising mirror and shined on the optical disc can be suppressed.

According to still another aspect of the invention, an optical pickup includes: a light source that emits light; a rising mirror that reflects the light emitted from the light source and directs the light to an optical disc; and a monitoring detector for controlling an output of the light emitted from the light source. The rising mirror is composed of the reflective optical element of the invention. The plurality of regions of the reflective optical element includes: a first region on which a central portion of a beam is made incident; and a second region on which a peripheral portion of the beam is made incident. The first region has optical properties that transmit incidence light at a predetermined transmittance. The monitoring detector detects the light transmitted through the first region of the reflective optical element, and controls optical output of the light source based on the detection result.

According to the configuration described above, the light emitted from the light source is directed to the optical disc via the rising mirror. In this case, since the rising mirror is composed of the reflective optical element of the invention, disturbance in the wave front of light reflected on the rising mirror and shined on the optical disc can be suppressed. Moreover, since the monitoring detector detects the light transmitted through the first region of the optical reflective element and controls the optical output of the light source based on the detection result, an optical pickup in a front monitoring method can be achieved and also super resolution effect can be provided which narrows down the spot of light condensed on the optical disc.

### BRIEF DESCRIPTION OF THE DRAWINGS

The above-mentioned and other objects and features of the present invention will be clarified, referring to preferred embodiments to be described below and the accompanying drawing indicating the following.

FIG. 1 is a cross section schematically showing the outline structure of a rising mirror in one example as a reflective optical element for use in an optical pickup according to one embodiment of the present invention;

FIG. 2 is an explanatory view showing the outline construction of the optical pickup;

FIG. 3 is a plan view showing one example of the structure of the rising mirror;

FIG. 4 is an explanatory view schematically showing intensity distribution of light incident on the rising mirror and intensity distribution of light reflected on the rising mirror;

FIG. 5 is a plan view showing another example of the structure of the rising mirror;

FIG. 6 is a plan view showing still another example of the structure of the rising mirror;

FIG. 7 is a plan view showing still another example of the structure of the rising mirror;

FIG. 8 is a plan view showing still another example of the structure of the rising mirror;

FIG. 9 is an explanatory view schematically showing how an incidence beam is reflected on the rising mirror;

FIG. 10 is a plan view showing the outline structure of the rising mirror of FIG. 1;

FIG. 11 is an explanatory view showing the layer structure of a first region of the rising mirror;

FIG. 12 is an explanatory view showing the layer structure of a second region of the rising mirror;

FIG. 13 is a graph showing the reflection properties of the first region;

FIG. 14 is a graph showing the reflection properties of the second region;

FIG. 15 is an explanatory view showing phase delay differences in reflected light between the first region and the second region, with various adjusted thicknesses of a phase adjustment layer of the rising mirror;

FIG. 16 is a plan view showing the outline structure of the rising mirror in another example;

FIG. 17 is a cross section showing the outline structure of the rising mirror;

FIG. 18 is an explanatory view showing the layer structure of a second region of the rising mirror;

FIG. 19 is a graph showing the reflection properties of a first region of the rising mirror;

FIG. 20 is a graph showing the reflection properties of the second region;

FIG. 21 is an explanatory view showing phase delay differences in reflected light between the first region and the second region, with various adjusted thicknesses of a phase adjustment layer of the rising mirror;

FIG. 22A through FIG. 22J are cross sections showing in combination the manufacturing processes of the rising mirror in the examples;

FIG. 23 is a cross section showing the outline structure of a variable aperture separation filter for use in a conventional optical pickup; and

FIG. 24 is a plan view of the variable aperture separation filter.

### DETAILED DESCRIPTION OF THE PREFERRED EMBODIMENTS

Referring to the accompanying drawings, one embodiment of the present invention will be described below.

(1. Optical Pickup Construction)

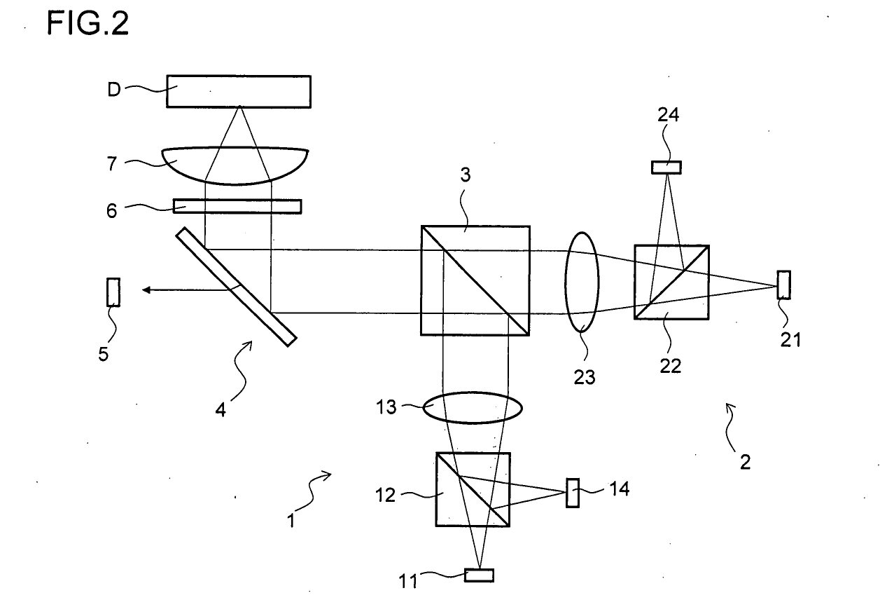

FIG. 2 is an explanatory view showing the outline construction of the optical pickup according to this embodiment. The optical pickup has a first light source part 1, a second light source part 2, a dichroic prism 3, a rising mirror 4, a monitoring detector 5, a ¼ wavelength plate 6, and an objective lens 7.

The first light source part 1 has a light source 11, a polarizing beam splitter (hereinafter abbreviated as PBS) 12, a collimating lens 13, and a photoreceptor 14. The light source 11 emits, as an optical beam, laser light having a wavelength of, for example, 405 nm (blue laser). The PBS 12 transmits linearly polarized laser light (for example, P-polarized light) emitted from the light source 11, and reflects light from an optical disc D (for example, S-polarized light) and directs this light to the photoreceptor 14. The collimating lens 13 collimates laser light incident thereon via the PSB 12. The photoreceptor 14 receives light returning from the optical disc D and incident thereon via the PBS 12. Through the reception of light on the photoreceptor 14, servo signals (a focus error signal, a tracking error signal), information signals, aberrations signals, and the like are detected upon recording and reproduction on the high-density recording optical disc corresponding to a blue laser.

The second light source part 2 has a light source 21, a polarizing beam splitter (hereinafter abbreviated as PBS) 22, a collimating lens 23, and a photoreceptor 24. The light source 21 emits, as optical beams, for example, laser light having a wavelength of 660 nm (for DVD) and laser light having a wavelength of 785 nm (for CD). That is, the light source 21 is a light source that emits two types of laser light respectively having different wavelengths. The PBS 22 transmits linearly polarized laser light (for example, P-polarized light) emitted from the light source 21, and reflects light returning from the optical disc D (for example, S-polarized light) and directs this light to the photoreceptor 24. The collimating lens 23 collimates laser light incident thereon via the PSB 22. The photoreceptor 24 receives light returning from the optical disc D and incident thereon via the PBS 22. Through the reception of light on the photoreceptor 24, servo signals (a focus error signal, a tracking error signal), information signals, aberrations signals, and the like are detected upon recording and reproduction on the DVD or the CD.

The dichroic prism 3 reflects laser light supplied from the first light source 1 and thereby directs the light to the rising mirror 4, and also transmits laser light supplied from the second light source part 2 and thereby directs the light to the rising mirror 4. That is, the dichroic prism 3 is an optical path altering element that alters the travel directions of laser light incident from different directions to the same direction upon their emergence therefrom.

The rising mirror 4 is arranged between the light sources 11, 21 and the optical disc D, more specifically, in the optical path between the dichroic prism 3 and the objective lens 7, and is capable of bending the optical path of laser light emitted from the dichroic prism 3 toward the optical disc D. This rising mirror 4 is usually supposed to reflect all laser light incident thereon and then directs the light toward the optical disc D. However, in this embodiment, the rising mirror 4 directs some of the laser light emitted from the light sources 11 and 21 toward the monitoring detector 5 while directing the remaining laser light toward the optical disc D. That is, in this embodiment, the rising mirror 4 functions as a monitoring optical element. For details of the rising mirror 4, a description will be given later.

The monitoring detector 5 receives some of laser light emitted from the light sources 11 and 21, and is composed of, for example, a photodiode and a control part. In this embodiment, the monitoring detector 5 detects light transmitted through a first region 31, to be described later (see FIG. 4), of the rising mirror 4, and controls optical output from the light sources 11 and 21 based on the detection results. In this embodiment, a front monitor method is employed in which laser light emitted forward (toward the optical disc D) from the light sources 11 and 21 is monitored via the rising mirror 4 by the monitoring detector 5.

The ¼ wavelength plate 6 converts linearly polarized light (for example, P-polarized light), which has been reflected on the rising mirror 4, into circularly polarized light and converts light (circularly polarized light) returning from the optical disc D into linearly polarized light (for example, S-polarized light). The objective lens 7 condenses on the optical disc D light which has been reflected on the rising mirror 4 and then has been obtained via the ¼ wavelength plate 6.

In the construction described above, of linearly polarized laser light emitted from the light source 11, for example, the P-polarized light is transmitted through the PBS 12 and then is made incident on the collimating lens 13. Then the laser light collimated by the collimating lens 13 is reflected on the dichroic prism 3 and then made incident on the rising mirror 4. On the other hand, of linearly polarized laser light emitted from the light source 21, for example, the P-polarized light is transmitted through the PBS 22 and then made incident on the collimating lens 23. Then the laser light collimated on the collimating lens 23 is transmitted through the dichroic prism 3 and then made incident on the rising mirror 4.

On the rising mirror 4, some of the laser light emitted from the light sources 11 and 12 are directed to the monitoring detector 5 so as to be monitored by the monitoring detector 5. On the other hand, the remaining light emitted from the light sources 11 and 21 is reflected on the rising mirror 4, converted into circularly polarized light by the ¼ wavelength plate 6, and then condensed onto the optical disc D by the objective lens 7.

The light returning from the optical disc D is made incident, again via the objective lens 7, on the ¼ wavelength plate 6, where the light is converted into linearly polarized light (for example, S-polarized light), and then the light is made incident on the rising mirror 4 on which the light is reflected, and then made incident on the dichroic prism 3. At this point, if the returning light is the one emitted from the light source 11, the returning light made incident on the dichroic prism 3 is reflected on the dichroic prism 3, and then made incident on the PBS 12 via the collimating lens 13. On the PBS 12, the returning light that has been incident thereon is reflected, and then the light is received on the photoreceptor 14. On the other hand, if the returning light is the one emitted from the light source 21, the returning light made incident on the dichroic prism 3 is transmitted through the dichroic prism 3, and then made incident on the PBS 22 via the collimating lens 23. The incident returning light is then reflected on the PBS 22 and received on the photoreceptor 24.

(2. Details of Rising Mirror)

(2-1. Structure of the Rising Mirror Excluding Phase Adjustment Layer)

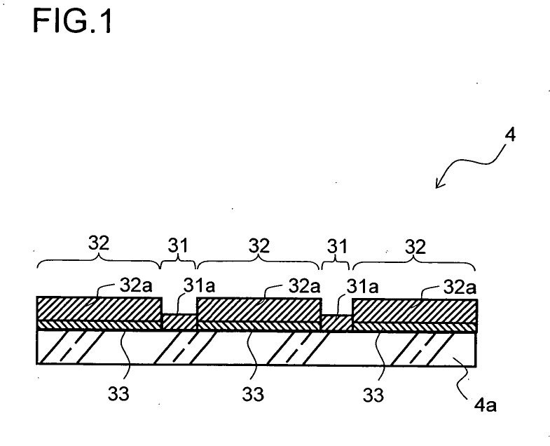

Next, a description will be given on the details of the rising mirror 4. The rising mirror 4 of this embodiment has a most significant feature that the phase adjustment layer 33 (see FIG. 1) is provided, which will be described later. The structure excluding this feature will be first described below.

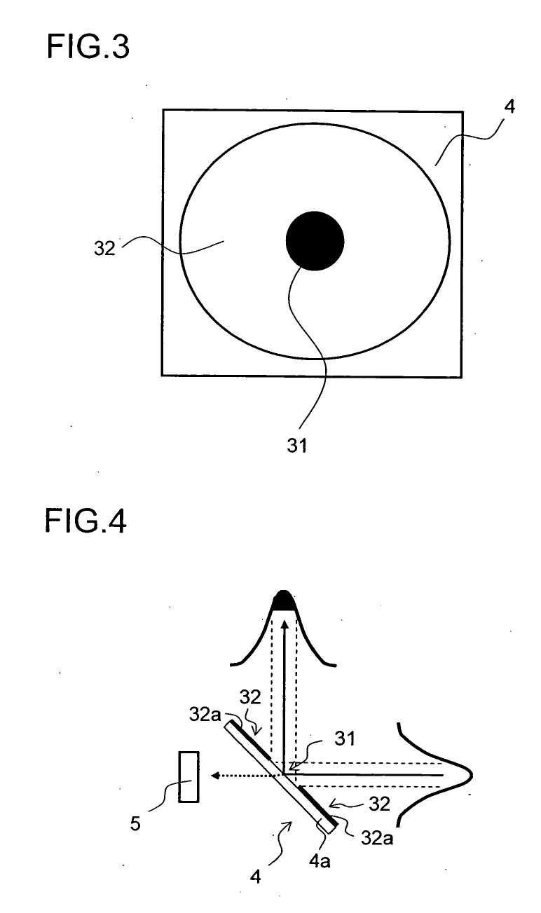

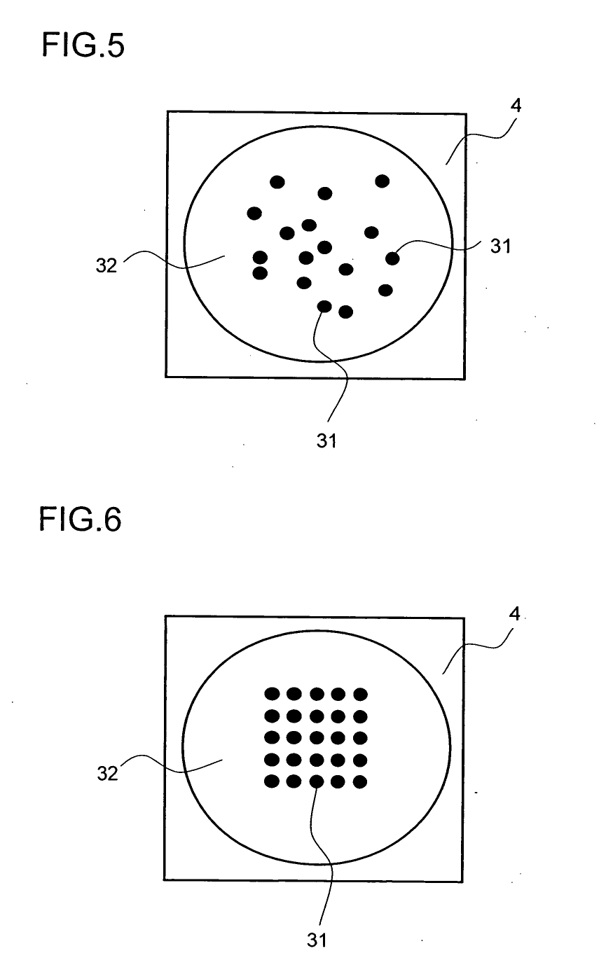

FIG. 3 is a plan view schematically showing the outline structure of the rising mirror 4 of this embodiment. FIG. 4 is an explanatory view schematically showing intensity distribution of light incident on the rising mirror 4 and intensity distribution of light reflected on the rising mirror 4. In FIG. 4, the phase adjustment layer 33 (see FIG. 1) is omitted from illustration for convenience of explanation. This rising mirror 4 forms a reflective optical element with a first region 31 and a second region 32 having mutually different optical properties, for example, reflection properties. In FIG. 3, the first region 31 is painted in black for the purpose of clear distinction between the first region 31 and the second region 32 (which similarly applies to FIGS. 5 through 8 to be described later).

The first region 31 is a region for directing some of laser light emitted from the light sources 11 and 21 to the monitoring detector 5, i.e., a transmissive region for transmitting incidence light with a predetermined transmittance in this embodiment. This first region 31 can be formed by, for example, forming a general antireflection film on a glass substrate 4a as a transparent substrate. However, as shown in FIG. 4, the first region 31 can also be formed by letting light pass straight therethrough without providing any antireflection film on the glass substrate 4a. The first region 31 has low reflectance set around wavelengths of 405 nm, 660 nm, and 785 nm, and thus is capable of transmitting laser light of these wavelengths for monitoring.

The second region 32, on the other hand, is a region for directing the remaining laser light emitted from the light sources 11 and 21 (i.e., the laser light other than that incident on the first region 31) to the optical disc D. In FIG. 3, the line representing the outer edge of the second region 32 represents the outer edge of a beam of laser light incident on the rising mirror 4. This second region 32 is a reflective region for reflecting incidence light at a predetermined reflectance. In this embodiment, the second region 32 is formed by forming a dielectric multilayer film 32a as a reflection film on the glass substrate 4a. Alternatively, the second region 32 may be formed by combining together the dielectric multilayer film 32a and a metal film on the glass substrate 4a.

The second region 32 has a reflectance of, for example, 96% or more, set at around wavelengths of 405 nm, 660 nm, and 785 nm. This permits most of laser light having wavelengths described above to be reflected on the second region 32 and thereby directed to the optical disc D so as to be supplied for recording and reproduction performed on the optical disc D.

Forming the reflection film of the second region 32 with, for example, aluminum only provides a reflectance as low as approximately 93%, thus resulting in low reflection (low strength of reflected light). Forming the reflection film of the second region 32 with, for example, silver advances the progress of corrosion over long-term usage, thus resulting in deteriorated reliability. Therefore, forming the reflection film of the second region 32 with at least the dielectric multilayer film 32a can provide a highly reliable rising mirror 4 without any concerns about corrosion caused by long-term usage.

As described above, the first region 31 and the second region 32 are formed on the glass substrate 4a; therefore, the rising mirror 4 is structured so that a plurality of regions having mutually different reflection properties are formed on the same plane.

As shown in FIG. 3, the first region 31 is formed inside (on the inner side of) the second region 32 on the glass substrate 4a. That is, the first region 31 is formed within the region at which a beam of laser light traveling toward the optical disc D hits the rising mirror 4. Especially in this embodiment, the first region 31 is, as seen on the plane that is located inside the second region 32 and that intersects the optical axes of light emitted from the light sources 11 and 21, formed in the shape of one spot that includes the aforementioned optical axes.

Forming the first region 31 in the shape of one spot that includes the optical axes in this way permits light near the optical axes, of those directed via the rising mirror 4 to the optical disc D, to be penetrated (i.e., transmitted at a predetermined transmittance) through the spot-like first region 31 toward the monitoring detector 5. This permits a decrease in the strength of laser light, only at around the optical axes, which is shined on the optical disc D. In this case, as shown in FIG. 4, the intensity distribution of light reflected on the rising mirror 4 is a transformed version of the intensity distribution of incidence light exhibiting Gaussian distribution, with the intensity around the optical axes slightly lower than that in the strength distribution of the incidence light. As a result, the spot of light condensed on the optical disc D via the rising mirror 4 can be sharply narrowed down, thus providing so-called super resolution effect that can be achieved even in high-density recording and reproduction.

The ability to provide a narrower optical spot on the optical disc D permits the optical disc D to be irradiated with an optical spot of an appropriate diameter, thus ensuring the recording and reproduction performed on the optical disc D, even when there exist some design errors in, for example, the objective lens 7 or the like. That is, the design error of an optical element composing the optical pickup can be absorbed with the design of the rising mirror 4 as described above.

The fact that the super resolution effect described above can be obtained proves that, in the rising mirror 4 of FIGS. 3 and 4, a plurality of regions formed on the glass substrate 4a with mutually different optical properties are composed of: the first region 31 on which the center portion of a beam emitted from the light sources 11 and 21 is made incident; and the second region 32 on which the peripheral portion of the beam is made incident, and that the first region 31 has an optical property that transmits incidence light at a predetermined transmittance.

In this case, it is preferable that the area of the first region 31 be set larger than or equal to 5% but smaller than or equal to 20% of the area of the second region 32. Such definition of the area ratio of the first region 31 to the second region 32 permits an appropriate amount of laser light to be supplied onto the optical disc D via the second region 32 while reliably obtaining monitored light via the first region 31. The effect of such definition of the area ratio can also be provided with the structures of FIGS. 5 through 8 to be described later.

When the first region 31 is formed into a spot-like shape as shown in FIG. 3, the first region 31 is located inside the second region 32, includes the optical axes of laser light emitted from the light sources 11 and 21, and is formed inside the region that occupies 80% of the area of the second region 32. In this case, the spot shape of the first region 31 may be a circle, an oval, or any other shape as long as it includes the optical axes.

The first region 31 described above may be formed at a plurality of locations within a region which extends inside the second region 32 or extends astride the inside and outside of the second region 32, and also within a plane that the optical axes of laser light emitted from the light sources 11 and 21 intersect. Hereinafter, such an example will be described, referring to FIGS. 5 through 8.

FIGS. 5 and 6 are plan views of the rising mirror 4 with the first region 31 formed in a plurality of spots inside the second region 32. FIG. 5 shows a case where a plurality of spots composing the first region 31 are randomly arranged inside the second region 32. FIG. 6 shows a case where a plurality of spots composing the first region 31 are arranged in a matrix form inside the second region 32.

Regularly arranging a plurality of spots as the first region 31 may cause optical interference attributable thereto, thus disturbing imaging performed on the optical disc D. Considering this point, it is preferable that the plurality of spots of the first region 31 be randomly arranged inside the second region 32. However, if no such interference occurs, the plurality of spots of the first region 31 may be arranged in a matrix form inside the second region 32.

When the first region 31 is formed in a plurality of spots as described above, it is preferable that each spot be shaped into a circle having a diameter of between 0.01 mm to 0.1 mm, inclusive. This permits a sufficient amount of light required for monitoring to be reliably obtained via the first region 31.

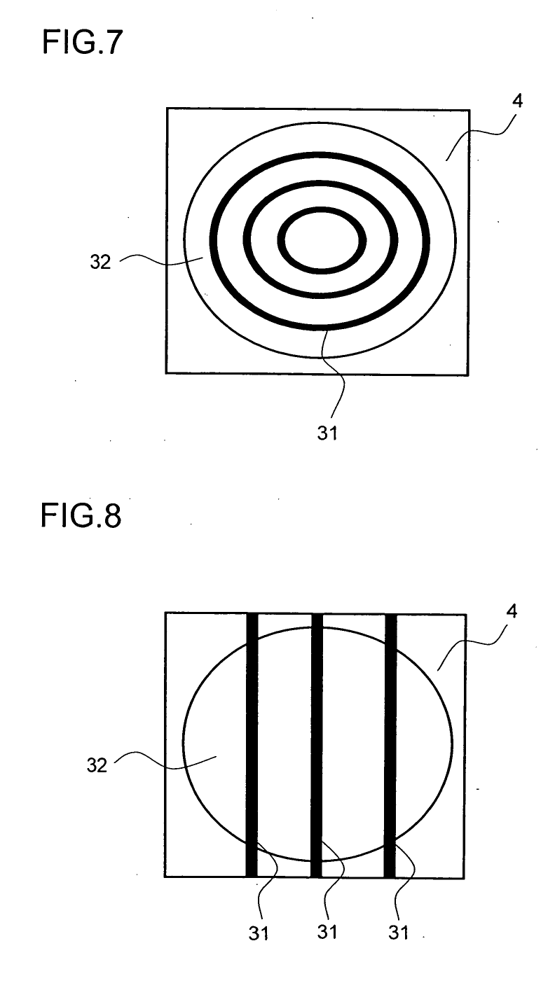

FIG. 7 is a plan view of the rising mirror 4 with the first region 31, on the glass substrate, formed in the shape of a plurality of rings inside the second region 32 and within the plane that the optical axes of laser light emitted from the light sources 11 and 21 intersect. More specifically, in FIG. 7, the first region 31 is formed in the shape of a plurality of rings that are arranged not in contact with each other so as to surround the aforementioned optical axes. Forming the first region 31 even in this manner permits appropriate control of the amount of light based on monitored light obtained via the region formed in the shape of a plurality of rings.

In this case, to reliably obtain via the first region 31 light having sufficient amount of light required for monitoring, it is preferable that the line width of the rings described above be between 0.01 mm and 0.1 mm, inclusive. In FIG. 7, the first region 31 is formed in a plurality of rings, but it may also be formed in one ring.

FIG. 8 is a plan view of the rising mirror 4 with the first region 31 formed in the shape of a plurality of slits within the plane that the optical axes of laser light emitted from the light sources 11 and 21 intersect. In FIG. 8, the first region 31 is formed with a slit that passes through the optical axes and a plurality of slits that are so arranged as to be bilaterally symmetric to each other with respect to the aforementioned slit as an axis of symmetry. Forming the first region 31 even with such slits permits appropriate control of the amount of light based on monitored light obtained via these slits. The slit-shape of the first region 31 eases production of a mask corresponding to the slit, and thus eases production of the rising mirror 4 with this mask.

As shown in FIG. 8, forming the first region 31 so as to be bilaterally symmetric with respect to the slit passing through the aforementioned optical axes can reduce distortion of the optical spot of an optical beam shined on the optical disc via the second region 32 to a minimum, compared to the case where the first region 31 is asymmetrically formed.

These slits as the first region 31 may be so formed as to extend astride the inside and outside of the second region 32, as shown in FIG. 8, or may be formed only inside the second region 32. Moreover, as the first region 31, only one slit may be used which passes through the aforementioned optical axes. Furthermore, to reliably obtain via the first region 31 light having a sufficient amount of light required for monitoring, it is preferable that the slit have a width of between 0.01 mm and 0.1 mm, inclusive.

Thus, based on the structure of the rising mirror 4 described above referring to FIGS. 3 and 5 through 8, it can be concluded that the first region 31 is formed at least inside (on the inner side of) the second region 32.

As shown in FIGS. 5 through 8, when the first region 31 is formed at a plurality of positions on the glass substrate, these first regions 31 may be configured to have different optical properties (reflection properties and transmission properties). As shown in FIGS. 7 and 8, when the second region 32 is further divided into a plurality of regions by the first region 31, these second regions 32 may be configured to have different optical properties.

Providing different optical properties among the first regions 31 and also among the second regions 32 in this way permits providing mutually different intensity distributions of reflected light depending on, for example, the type of the optical disc D used. That is, depending on the type of the optical disc D used, a spot formed on the optical disc D may be narrowed down, for example, in the circumferential direction or radial direction of the optical disc D. Accordingly, a favorable SN ratio can be obtained in accordance with the type of the optical disc D used.

Based on the description above, it can be concluded that the number of regions formed on the glass substrate and having different optical properties is at least two. That is, if one first region 31 and one second region 32 are formed on the glass substrate, the number of regions described above is two including the first region 31 and the second region 32. When the first region 31 and/or the second region 32 are formed at a plurality of positions and also they have mutually different optical properties, the number of regions formed on the glass substrate and having different optical properties is at least three.

As described above, on the rising mirror 4 of this embodiment, a plurality of regions having different reflection properties (first region 31 and second region 32) are formed on the same plane. Thus, of light emitted from the optical sources 11 and 21, the light transmitted through the first region 31 of the rising mirror 4 at a predetermined transmittance can be directed, as monitored light, to the monitoring detector 5 while the light reflected on the first region 31 and the second region 32 at a predetermined reflectance can be directed to the optical disc D via the objective lens 7. That is, a front monitoring method can be achieved which obtains monitored light before the light sources 11 and 21 (on the objective lens 7 side), thereby providing effects to be described below.

The light amount ratio between monitored light separated by the rising mirror 4 and disc reproducing light is practically determined by the ratio of area between the first region 31 and the second region 32. Therefore, even in the event of fluctuations in the wavelength of light incident on the rising mirror 4 due to variations in the light sources 11 and 21 at the time of production or temperature change, light incident on the first region 31 can be used as monitored light regardless of the wavelength fluctuations. Thus, even in the event of variation in the light sources 11 and 21 or temperature change, the amount of light can be appropriately controlled based on the monitored light.

The reflectance of the second region 32 easily fluctuates within approximately 1% due to manufacturing errors. For the rising mirror 4 of this embodiment, the light amount ratio between monitored light and disc reproducing light is practically determined by the ratio of area between the first region 31 and the second region 32. Therefore, disc reproducing light can be obtained under almost no influence of variations in the reflectance of the second region 32 (caused by manufacturing errors).

The rising mirror 4 has the first region 31 for extracting monitored light; therefore, this eliminates the need for providing, separately from the rising mirror 4, an optical element designated for extracting monitored light. Therefore, even when a plurality of light sources 11 and a plurality of light sources 21 are provided in correspondence with different wavelengths, the structure such that light of different wavelengths is made incident on the rising mirror 4 permits composing a monitoring optical element with only one rising mirror 4, thus avoiding complication and cost increase of the device.

(2-2. Viewpoints on Phase Adjustment)

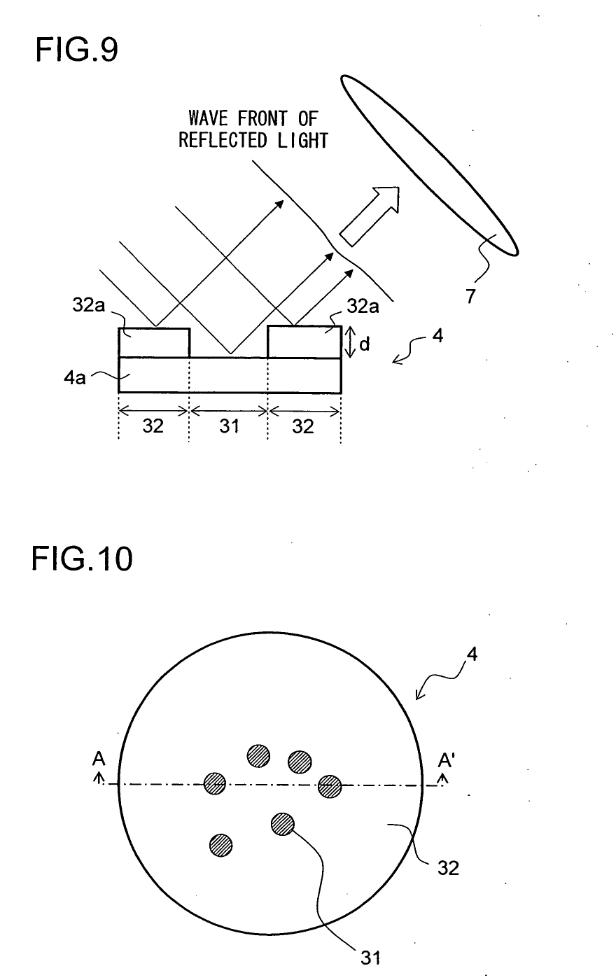

Next, before proceeding to the phase adjustment layer 33 (see FIG. 1) of the rising mirror 4, viewpoints on phase adjustment will be described. FIG. 9 schematically shows how an incidence beam is reflected on the rising mirror 4. In FIG. 9, the rising mirror 4 is not provided with a phase adjustment layer, and the ¼ wavelength plate 6 is omitted from illustration.

Now, assume that linearly polarized light enters the surface of the glass substrate 4a of the rising mirror 4 at an angle of incidence of for example, 45 degrees. When this linearly polarized light is P-polarized light, the phase delay of reflected light with respect to incidence light arises by Pp1 for the first region 31 and by Pp2 for the second region 32. Between the first region 31 and the second region 32, there is provided a physical step difference d corresponding to the thickness of the dielectric multilayer film 32a, as shown in FIG. 9. The phase delay caused by this step difference d is represented by 2d×cos 45°. Thus, to avoid disturbance in the wave front of light reflected on the first region 31 and the second region 32 as a whole, that is, to avoid an optical difference step, it is favorable that relationship below be satisfied:
2mλ=(2d×cos 45°+Pp2)−Pp1 (1)
where m represents an integer number, and

λ represents the wavelength used.

To satisfy this relational expression (1), a phase adjustment layer may be provided on the glass substrate 4a of the rising mirror 4 and its thickness may be set at an appropriate value.

This phase adjustment will be described in detail below. It is possible that, depending on intended use of a reflective optical element having on the same plane a plurality of regions with different reflection properties, circularly polarized light may be made incident on the plurality of regions of the reflective optical element. In this case, to suppress disturbance in the wave front of reflected light as a whole obtained via the plurality of regions, it is required to eliminate not only a phase difference between P-polarized light but also a phase difference between S-polarized light in the plurality of regions. On the contrary, when linearly polarized light is made incident on the plurality of regions, it is only required to consider one of these phase differences. Thus, the viewpoints on phase adjustment described below will refer to a case where circularly polarized light is made incident on the first region 31 and the second region 32 having different optical properties.

Generally speaking, “phase difference” represents a phase difference between S-polarized light and P-polarized light. A phase difference between S-polarized light astride a plurality of regions (the first region 31 and the second region 32) and a phase difference between P-polarized light astride the plurality of regions are both important in this embodiment; therefore, for discriminating these phase differences from the aforementioned phase differences, these phase differences will be referred to as “phase delay differences”.

To eliminates the phase delay differences both between S-polarized light and between P-polarized light, the phase difference needs to be eliminated for both reflected light on the first region 31 and reflected light on the second region 32. The reason is that since the phase delay difference that is adjustable with the thickness of the phase adjustment layer are equal between S-polarized light and P-polarized light, unless the initial phase difference is equal between the two regions (first region 31 and second region 32), only either of the S-polarized light and the P-polarized light can be adjusted.

Assume that Sp1 and Pp1 represent a phase of S-polarized light and a phase of P-polarized light, respectively, that are obtained via the first region 31, Δ1 represents a phase difference therebetween, Sp2 and Pp2 represent a phase of S-polarized light and a phase of P-polarized light, respectively, that are obtained via the second region 32, and Δ2 represents a phase difference therebetween. Assume also that DS represents a phase delay difference between S-polarized light and DP represents a phase delay difference between P-polarized light. In this condition, Δ1, Δ2, DS and DP are expressed as follows:
Δ1=Sp1−Pp1 (2)
Δ2=Sp2−Pp2 (3)
DS=Sp1−Sp2 (4)
DS=Pp1−Pp2 (5)
Under the condition DS=DP=0, phase delay differences between S-polarized light and between P-polarized light is eliminated.

When Δ1=Δ2, a formula below is obtained based on formulae (2) and (3):
Sp1−Pp1=Sp2−Pp2
Sp1−Sp2=Pp1−Pp2 (6)
Therefore, based on formulae (4), (5), and (6), a relationship below is established:
DS=DP (7).

Now, assume that, for example, a phase adjustment layer having a refractive index n and a thickness d is inserted in the second region 32, where θ represents an angle of incidence, λ represents the wavelength used, DS′ represents a phase delay difference between S-polarized light after phase adjustment, and DS′ represents a phase delay difference between P-polarized light after phase adjustment.

For example, when light is transmitted through the first region 31 and the second region 32, DS′ and DP′ are expressed as follows:

$$\begin{matrix}\begin{matrix}{DS}^{′} = ( Sp 1 + ( 2 π d cos θ ) / λ ) - ( Sp 2 + ( 2 π nd cos θ ) / λ ) \\ = ( Sp 1 - Sp 2 ) - ( 2 π ( n - 1 ) d cos θ ) / λ \\ = DS - ( 2 π ( n - 1 ) d cos θ ) / λ\end{matrix} & ( 8 ) \\ \begin{matrix}{DP}^{′} = ( Pp 1 + ( 2 π d cos θ ) / λ ) - ( Pp 2 + ( 2 π nd cos θ ) / λ ) \\ = ( Pp 1 - Pp 2 ) - ( 2 π ( n - 1 ) d cos θ ) / λ \\ = DP - ( 2 π ( n - 1 ) d cos θ ) / λ\end{matrix} & ( 9 )\end{matrix}$$

Therefore, appropriately selecting n and d so as to obtain DS′=0, based on formula (8), a relationship below can be obtained:
(2π(n−1)d cos θ)/λ=DS (10).
Therefore, substituting formula (10) for formula (9), formula below is obtained:
DP′=DP−DS (11).
As a result, based on formulae (7) and (11),
DP′=0
is obtained.
That is, by inserting the phase adjustment layer having the refractive index n and the thickness d in the second region 32 and then appropriately selecting n and d so as to obtain DS′=0, the phase delay differences between S-polarized light and between P-polarized light can be eliminated. Note that the selection of n and d in this way simultaneously satisfies the formula (1) described above.

On the other hand, when light is reflected on the first region 31 and the second region 32, the phase delay on the second region 32 cannot be simply expressed with formulae (8) and (9) depending on where the phase adjustment layer is inserted. However, the phase delay on the first region 31 becomes equal to 4πnd cos θ/λ. Therefore, based on the same idea as described above, the phase delay difference between S-polarized light and between P-polarized light can be eliminated.

(2-3. The Structure of the Rising Mirror Including the Phase Adjustment Layer)

Next, based on the idea described above, the rising mirror 4 of the invention provided with the phase adjustment layer will be described based on Examples 1 and 2. Examples 1 and 2 will be described, referring to the structure of FIG. 5, that is, the case where a plurality of first regions 31 are randomly formed inside (on the inner side of) the second region 32. The structure in which the phase adjustment layer is provided is also applicable to any of FIGS. 3 and 6 to 8 described above.

### 2-3-1. EXAMPLE 1

FIG. 10 is a plan view showing the outline structure of the rising mirror 4 of this example. FIG. 1 is a cross section, taken on line A-A of FIG. 10. In this example, the first region 31 has on a glass substrate 4a an antireflection film 31a as an optical thin film. A second region 32 is structured by laminating on the glass substrate 4a a dielectric multilayer film 32a (including a case where a metal film is combined together) as an optical thin film with a phase adjustment layer 33 in between.

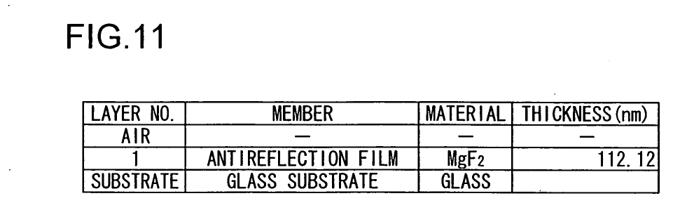

FIG. 11 is an explanatory view showing the layer structure of the first region 31. The antireflection film 31a is composed of one MgF₂ layer. Alternatively, the antireflection film 31a may be composed of a multilayer antireflection film having a higher antireflection performance. The MgF₂ has a refractive index of 1.38 for all three wavelengths, 405 nm, 660 nm, and 785 nm.

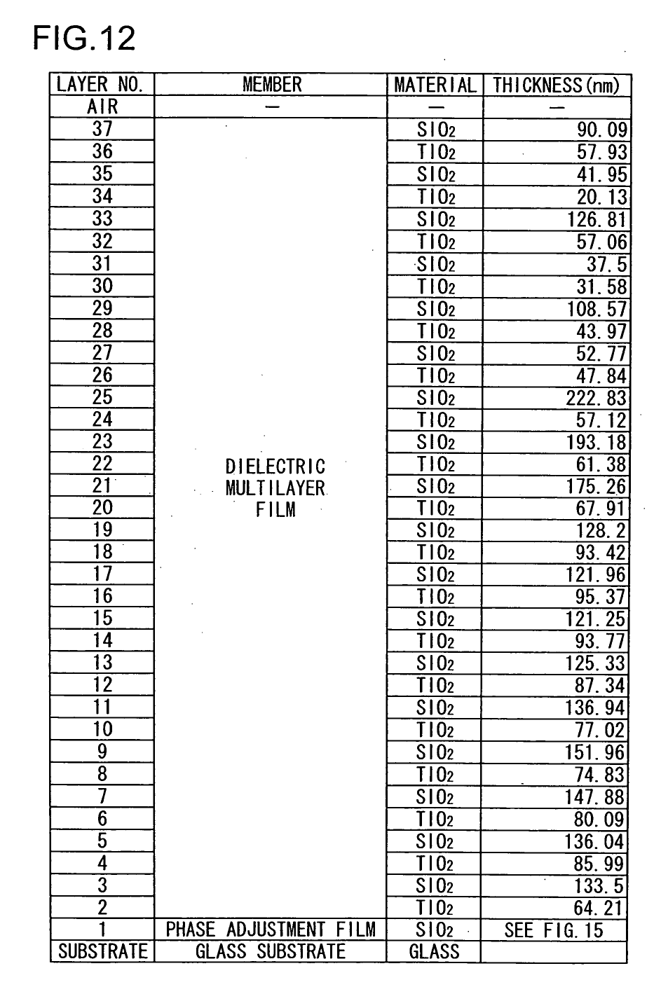

FIG. 12 is an explanatory view showing the layer structure of the second region 32. In this figure, the layers laminated on the glass substrate 4a are expressed in Layer 1, Layer 2, . . . . Layer 37 in order of position from the glass substrate 4a side. Note that the number of layers is not limited to 37.

The first layer, the phase adjustment layer 33, is composed of, for example, one SiO₂ layer. The phase adjustment layer 33 may be composed of multiple layers. A dielectric multilayer film 32a formed on the phase adjustment layer 33 is a laminated structure formed with alternating SiO₂ and TiO₂ layers into a predetermined thickness. The SiO₂ layer has reflective indexes of 1.47, 1.45, and 1.44 for light having wavelengths of 405 nm, 660 nm, and 785 nm, respectively. The TiO₂ layer has reflective indexes of 2.64, 2.34, and 2.30 for light having wavelength of 405 nm, 660 nm, and 785 nm, respectively.

It is preferable that the phase adjustment layer 33 have a refractive index equivalent to that of the glass substrate 4a located therebelow. The reason is that a difference in the refractive index between the phase adjustment layer 33 and the glass substrate 4a causes a change in the reflection properties of the second region 32 in the event of a change in the thickness of the phase adjustment layer 33. That is, providing the phase adjustment layer 33 with a refractive index equivalent to that of the glass substrate 4a provides constant reflection properties of the second region 32 even in the event of a change in the thickness of the phase adjustment layer 33.

More specifically, it is preferable that the difference in the refractive index between the glass substrate 4a and the phase adjustment layer 33 be 0.07 or below. This preferable difference is based on that glass has refractive indexes of approximately 1.51 to 1.53 for light having wavelengths of 400 nm to 785 nm while SiO₂ has refractive indexes of approximately 1.44 to 1.47 for light having wavelengths of 400 nm to 785 nm.

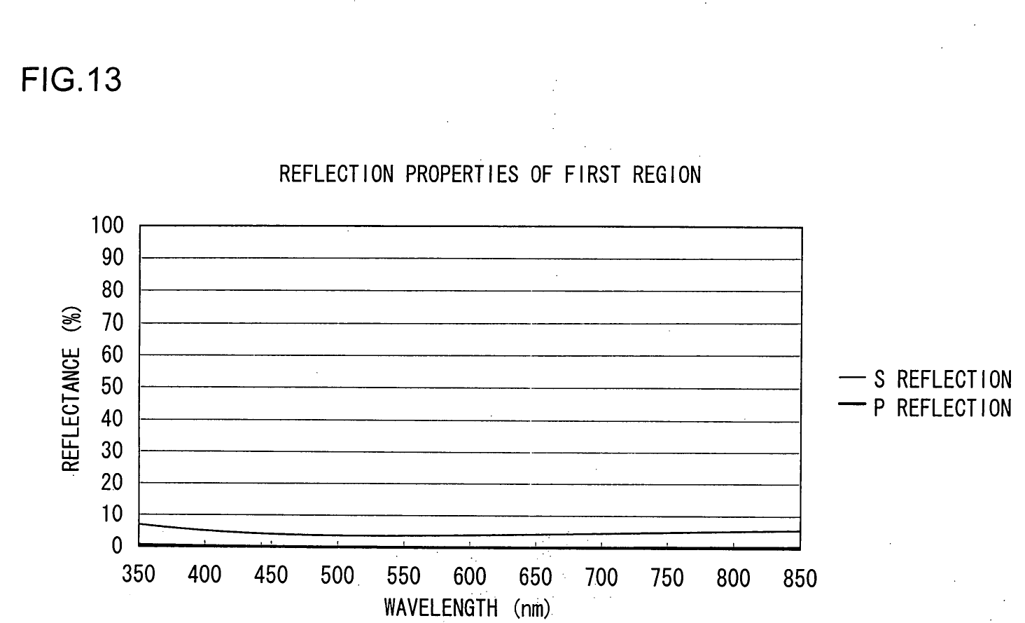

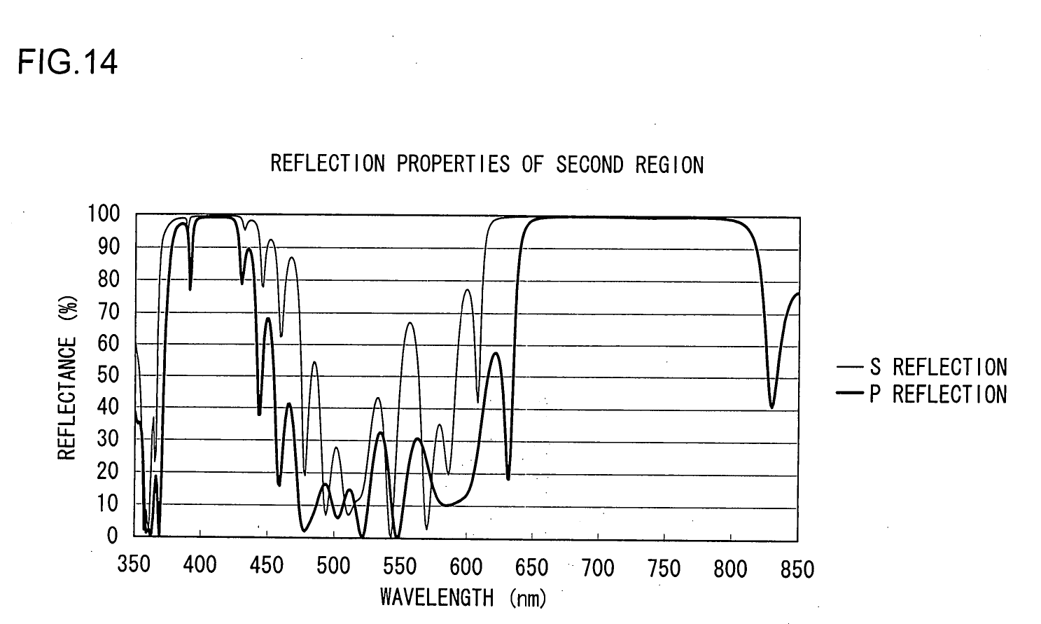

FIG. 13 is a graph showing the reflection properties (spectral reflectance) of the first region 31. FIG. 14 is a graph showing the reflection properties (spectral reflectance) of the second region 32. In the first region 31, the reflectance is, for example, 10% or below at wavelengths around 405 nm, 660 nm, and 785 nm for both P-polarized light and S-polarized light. In the second region 32, the reflectance is, for example, 96% or above at wavelengths around 405 nm, 660 nm, and 785 nm for both P-polarized light and S-polarized light.

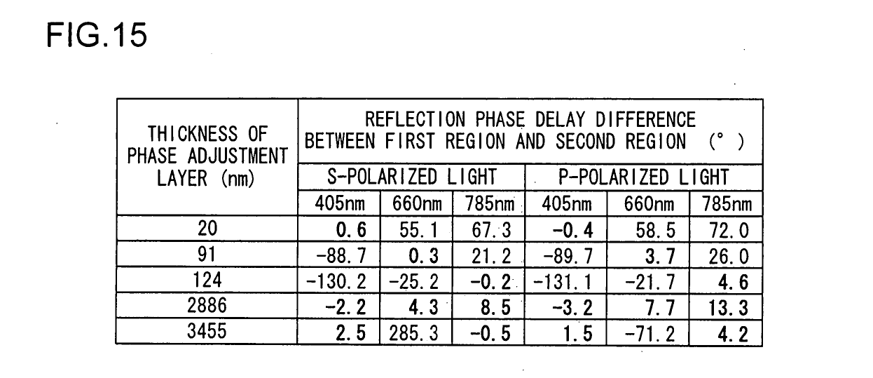

FIG. 15 shows phase delay differences in reflected light between the first region 31 and the second region 32 for light having wavelengths of 405 nm, 660 nm, and 785 nm, respectively, with various adjusted thicknesses of the phase adjustment layer 33 based on the layer structure of the dielectric multilayer film 32a of FIG. 12. In this figure, the phase delay differences close to 0° are boldfaced.

Referring to this figure, the following conclusion is drawn. With thicknesses of, for example, 20 nm, 2886 nm, and 3455 nm of the phase adjustment layer 33, for light having a wavelength of 405 nm, the phase delay difference is close to 0° for both the P-polarized light and the S-polarized light. With thicknesses of, for example, 91 nm and 2886 nm of the phase adjustment layer 33, for light having a wavelength of 660 nm, the phase delay difference is close to 0° for both the P-polarized light and the S-polarized light. With thicknesses of, for example, 124 nm, 2886 nm, and 3455 nm of the phase adjustment layer 33, for light having a wavelength of 785 nm, the phase delay difference is close to 0° for both the P-polarized light and the S-polarized light. Therefore, among the wavelengths used, there is almost no phase delay difference on the rising mirror 4 and thus almost no disturbance in the wave front of reflected light as a whole.

Especially with a thickness of 2886 nm of the phase adjustment layer 33, for all the light having wavelengths of 405 nm, 660 nm, and 785 nm, respectively, the phase delay difference is close to 0° for both the P-polarized light and the S-polarized light; therefore, it is assumed that, for all the light having the wavelengths described above, there is almost no disturbance in the wave front of reflected light as a whole.

### 2-3-2. EXAMPLE 2

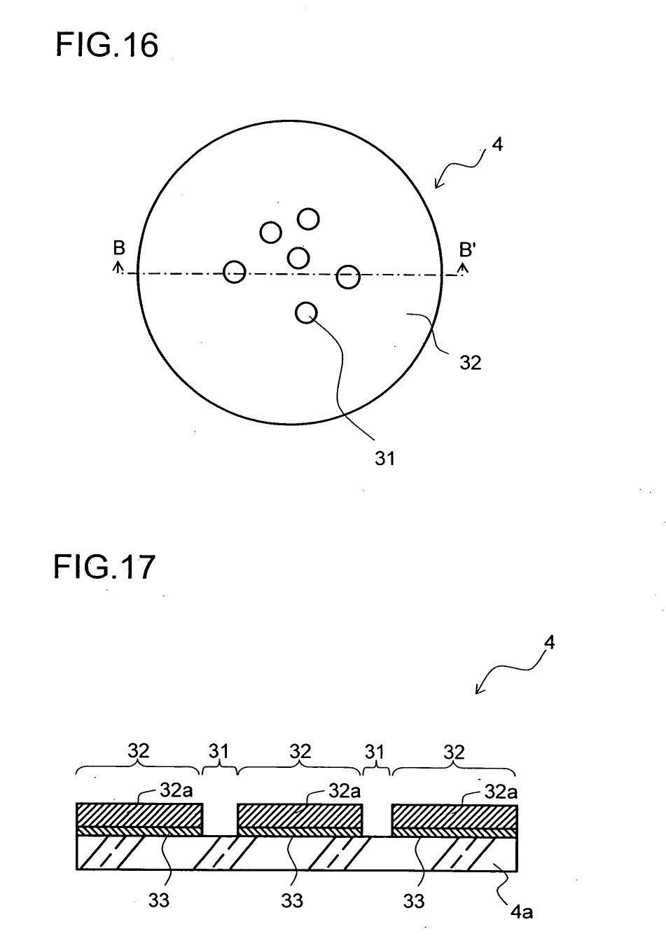

FIG. 16 is a plan view showing the outline structure of the rising mirror 4 of this example. FIG. 17 is a cross section, taken on line B-B of FIG. 16. In this example, a first region 31 has no antireflection film 31a on a glass substrate 4a, the surface of which is therefore uncovered. A second region 32 is structured by laminating on the glass substrate 4a a dielectric multilayer film 32a as an optical thin film with a phase adjustment layer 33 in between (including that combined with a metal film). That is, no phase adjustment layer is formed on the first region 31 having no optical thin film, but it is formed on the second region 32 having an optical thin film.

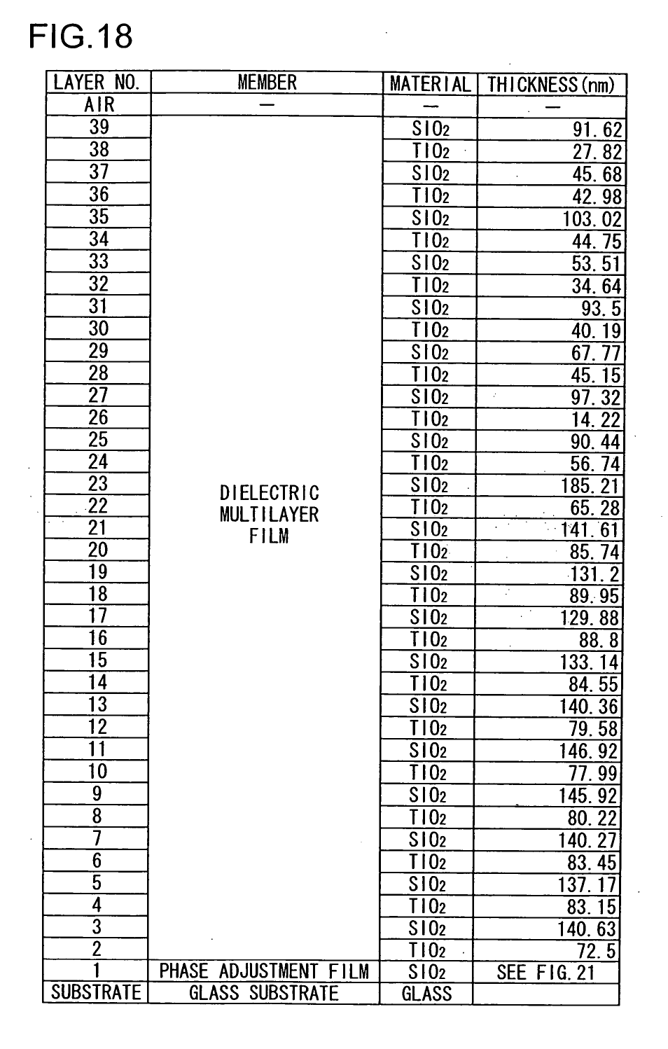

FIG. 18 is an explanatory view showing the layer structure of the second region 32. In this figure, the layers laminated on the glass substrate 4a are expressed in Layer 1, Layer 2, . . . . Layer 39 in order of position from the glass substrate 4a side. Note that the number of layers is not limited to 39.

The first layer, the phase adjustment layer 33, is composed of, for example, one SiO₂ layer, and has a refractive index equivalent to that of the glass substrate 4a. The phase adjustment layer 33 may be composed of multiple layers. A dielectric multilayer film 32a formed on the phase adjustment layer 33 is a laminated structure with alternating SiO₂ and TiO₂ layers into a predetermined thickness. The refractive indexes of the SiO₂ and TiO₂ layers are as indicated in Example 1.

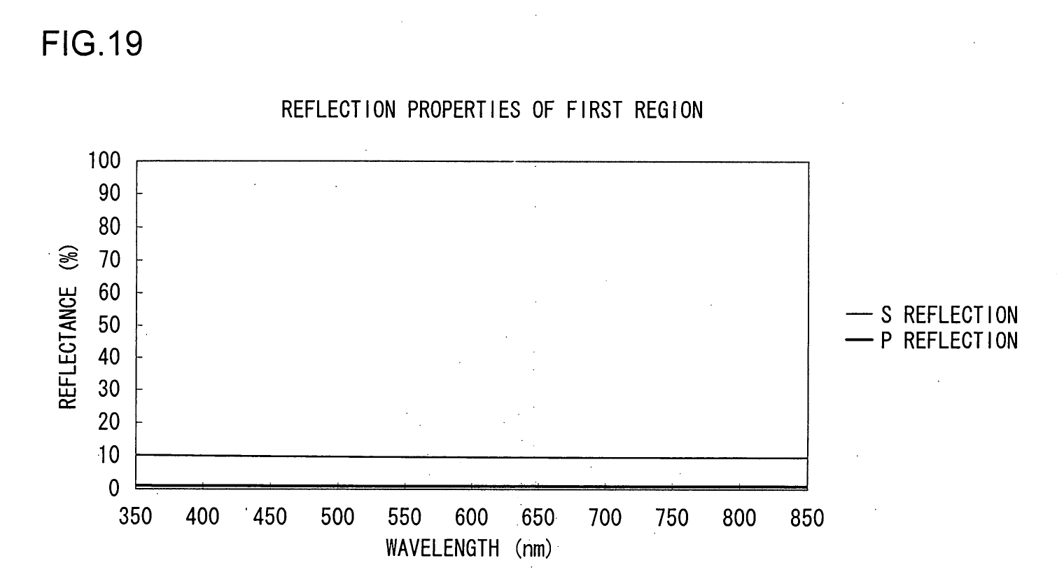

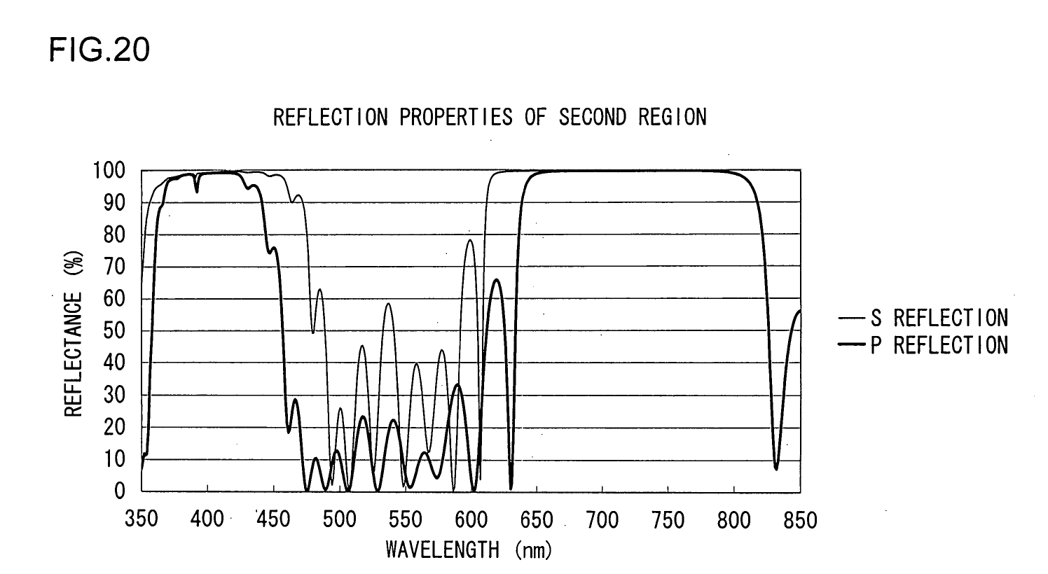

FIG. 19 is a graph showing the reflection properties (spectral reflectance) of the first region 31. FIG. 20 is a graph showing the reflection properties (spectral reflectance) of the second region 32. In the first region 31 the reflectance is, for example, 20% or below at wavelengths around 405 nm, 660 nm, and 785 nm for both the P-polarized light and the S-polarized light. In the second region 32, the reflectance is, for example, 96% or above at wavelengths around 405 nm, 660 nm, and 785 nm for both the P-polarized light and the S-polarized light.

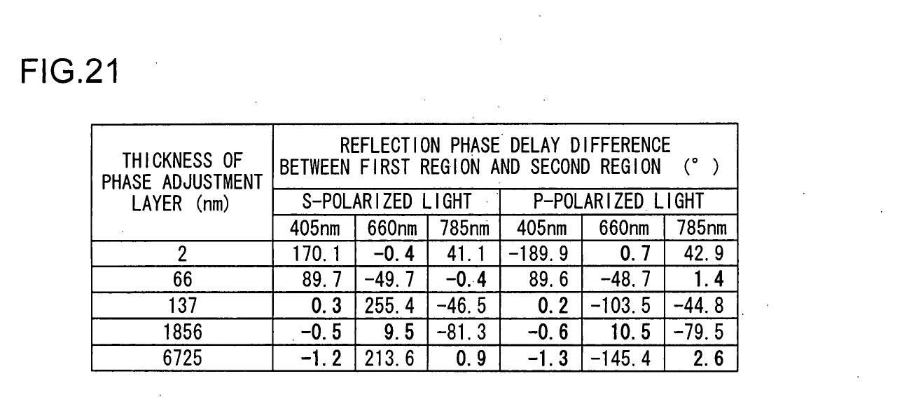

FIG. 21 shows phase delay differences in reflected light between the first region 31 and the second region 32 for light having wavelengths of 405 nm, 660 nm, and 785 nm, respectively, with various adjusted thicknesses of the phase adjustment layer 33 based on the layer structure of the dielectric multilayer film 32a of FIG. 18. In this figure, the phase delay differences close to 0° are boldfaced.

Referring to this figure, the following conclusion is drawn. With thicknesses of, for example, 2 nm and 1856 nm of the phase adjustment layer 33, for light having a wavelength of 660 nm, the phase delay difference is close to 0° for both the P-polarized light and the S-polarized light. With thicknesses of, for example, 66 nm and 6725 nm of the phase adjustment layer 33, for light having a wavelength of 785 nm, the phase delay difference is close to 0° for both the P-polarized light and the S-polarized light. With thicknesses of, for example, 137 mm, 1856 mm, and 6725 nm of the phase adjustment layer 33, for light having a wavelength of 405 nm, the phase delay difference is close to 0° for both the P-polarized light and the S-polarized light. Therefore, among the wavelengths described above, there is almost no phase delay difference on the rising mirror 4 and thus almost no disturbance in the wave front of reflected light as a whole.

Especially with a thickness of 1856 nm of the phase adjustment layer 33, for both light having wavelengths of 405 nm and 660 nm, respectively, the phase delay difference is close to 0° for both the P-polarized light and the S-polarized light. With a thickness of 6725 nm of the phase adjustment layer 33, for both light having wavelengths of 405 nm and 785 nm, respectively, the phase delay difference is close to 0° for both the P-polarized light and the S-polarized light. Thus, appropriately setting the thickness of the phase adjustment layer 33 can make the phase delay difference close to 0° for the two wavelengths. Thus, it can be assumed that the phase delay difference for all the three wavelengths can also be made close to 0° for both the P-polarized light and the S-polarized light, depending on the thickness of the phase adjustment layer 33.

Based on the fact that with a wavelength of 785 nm, the spot formed on the optical disc D does not have to be narrowed down as much as with the other wavelengths, it is assumed that the phase delay difference needs to be made close to 0° only for light having wavelengths of 405 nm and 660 nm, respectively.

As described in Examples 1 and 2, appropriately setting the thickness and refractive index of the phase adjustment layer 33 can reduce the phase delay difference (phase shift in reflected light) at the wavelengths used between a plurality of regions (the first region 31 and the second region 32) having different optical properties. When the phase shift in reflected light between the plurality of regions is between −10° and 0°, inclusive, or between 0° and 10°, inclusive, disturbance in the wave front of reflected beams as a whole obtained via these regions can be reliably suppressed. Therefore, it is preferable to set the thickness and refractive index of the phase adjustment layer 33 so that the range of phase shift in reflected light falls in the range described above. That is, it is preferable to adjust the phase of reflected light on a corresponding region (second region 32 where the phase adjustment layer 33 is formed) so that the phase shift in reflected light between the plurality of regions becomes between −10° and 0°, inclusive, or between 0° and 10°, inclusive.

By appropriately setting the thickness and refractive index of the phase adjustment layer 33, the adjustment of the phase of reflected light on a corresponding region by the phase adjustment layer 33 so as to eliminate phase shift in reflected light between a plurality of regions having different reflection properties permits elimination of disturbance in the wave front of reflected light as a whole obtained via these regions. Therefore, it is preferable that the phase adjustment layer 33 be provided if possible.

Examples 1 and 2 have been described above, referring to an example where the phase adjustment layer 33 is formed only on the second region 32 on which the dielectric multilayer film 32a as an optical thin film is formed. The same effect of suppressing the disturbance in the wave front of reflected light as a whole through phase adjustment can also be obtained by forming the phase adjustment layer 33 only on the first region 31 (including a case where the phase adjustment layer 33 is formed below the antireflection film 31a, if the antireflection film 31a is formed) or by forming the phase adjustment layer 33 both on the first region 31 and on the second region 32.

(3. How to Manufacture the Rising Mirror)

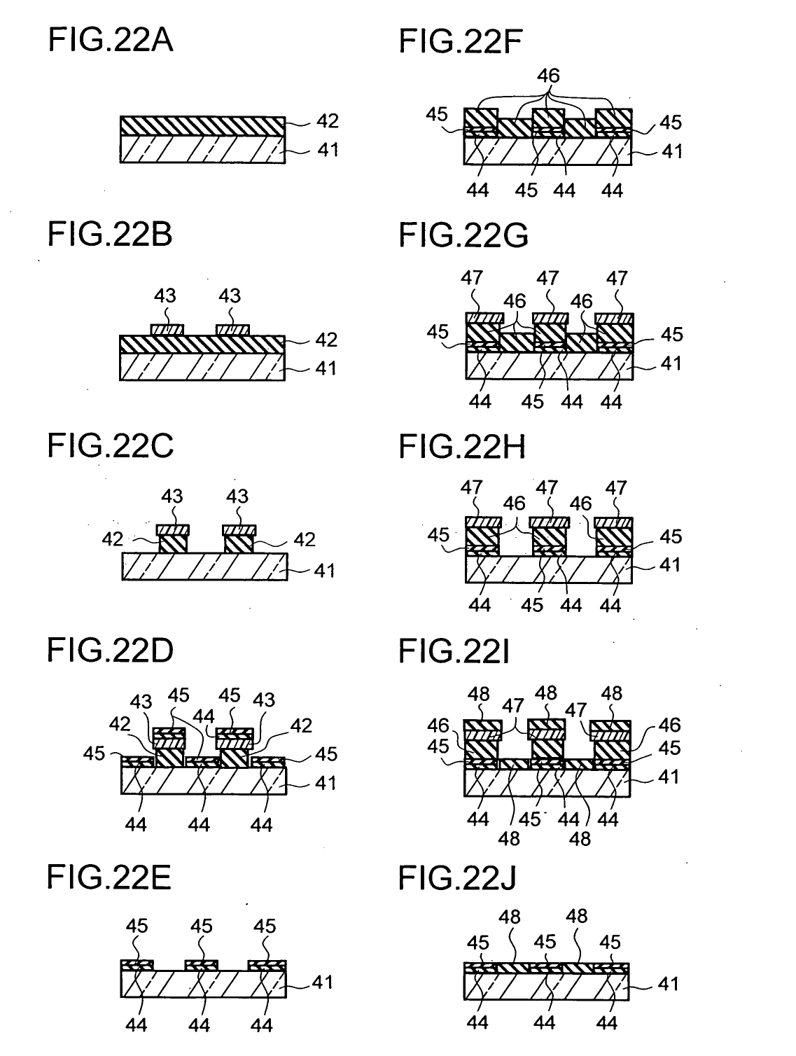

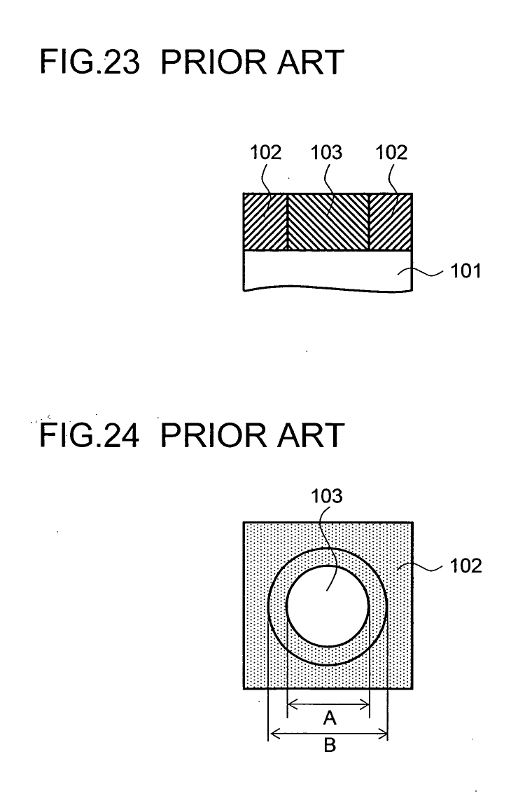

Next, a description will be given on how the rising mirror 4 in Examples 1 and 2 described above are manufactured, referring to FIGS. 22A to 22J.

On a glass substrate 41 corresponding to the glass substrate 4a, a sacrifice layer 42 (first sacrifice layer) having a thickness of approximately 1 μm is formed by sputtering (see FIG. 22A). This sacrifice layer 42 is formed of metal, for example, Cr or Al, since the use of such material facilitates film formation through sputtering or the like and also facilitates etching (facilitates dissolution in oxygen) in a later process.

Subsequently, on the sacrifice layer 42, as a first resist, photosensitive polyamide 43, photo-curable resin, is applied with a spin coater. In this embodiment, the photosensitive polyamide 43 has a heat resistance of approximately 300 degrees Celsius, but any material may be used which has a heat resistance of 200 degrees Celsius or above. From above a glass mask so formed as to have an opening corresponding to the first region 31, the photosensitive polyamide 43 is exposed (to ultraviolet radiation), developed, and then patterned. After the exposure, the portion of the photosensitive polyamide 43 other than its hardened portion is removed by cleaning with a solvent (see FIG. 22B).

Next, the exposed surface of the sacrifice layer 42 is etched with an etching agent (for example, manufactured by Nacalai Tesque Corporation under the name of ECR2) and cleaned with an organic solvent so that part of the sacrifice layer 42 remains in a pattern corresponding to the pattern of the photosensitive polyamide 43 (see. FIG. 22C). Through this process, the sacrifice layer 42 is so etched as to lie on the inner side of the photosensitive polyamide 43.

Then, on the glass substrate 41, for example, a phase adjustment layer 44 of SiO₂ and a dielectric multilayer film 45 having properties shown in FIG. 14 or 20 are formed in the order mentioned by, for example, vacuum evaporation method so as to cover the photosensitive polyamide 43 and the remaining sacrifice layer 42 (see FIG. 22D). The phase adjustment layer 44 corresponds to the phase adjustment layer 33 described above (see FIG. 1), and the dielectric multilayer film 45 corresponds to the dielectric multilayer film 32a described above (see FIG. 1). The dielectric multilayer film 45 is formed by being heated at, for example, 200 degrees Celsius or above.

As the dielectric multilayer film 45, for example, a multilayer film of metal oxide is a possible choice. Materials such as Ta₂O₅, TiO₂, and Nb₂O₃ having a refractive index of approximately 2 to 2.3, and SiO₂ and MgF₂ having a refractive index of approximately 1.3 to 1.5 can be used to form the dielectric multilayer film 45. In this embodiment, metal oxide (for example, TiO₂) having a high refractive index and metal oxide (for example, SiO₂) having a low refractive index are alternately superimposed to form the dielectric multilayer film 45.

Subsequently, the remaining sacrifice layer 42, and the phase adjustment layer 44 and the dielectric multilayer film 45 that are superimposed thereabove are etched and thereby removed (see FIG. 22E). As a result, the region where the phase adjustment layer 44 and the dielectric multilayer film 45 are not formed, that is, the region where the sacrifice layer 42 is removed, and the region where the phase adjustment layer 44 and the dielectric multilayer film 45 are formed remain.

The region where the sacrifice layer 42 is removed can also be provided as a transmissive region formed with the glass substrate only. The dielectric multilayer film 45, which is a reflective film having the properties shown in FIG. 14 or 20, serves as a reflective region. Therefore, the rising mirror 4 of Example 2 can be completed with the processes shown in FIGS. 22A up to 22E. In this case, the region where the sacrifice layer 42 is removed, which is a transmissive region, corresponds to the first region 31 of the rising mirror 4 (see FIG. 1). The region where the phase adjustment layer 44 and the dielectric multilayer film 45 are formed, which is a reflective region, corresponds to the second region 32 (see FIG. 1).

The rising mirror 4 of Example 1 can be completed by further subjecting the work in the state shown in FIG. 22E to the following processes.

More specifically, on the glass substrate 41 of FIG. 22E, a sacrifice layer 46 (second sacrifice layer) having a thickness of approximately 1 μm is formed by sputtering (see FIG. 22F). This sacrifice layer 46 is, as is the case with the sacrifice layer 42, formed of metal, for example, Cr or Al.

Subsequently, on the sacrifice layer 46, as a second resist, a photosensitive polyamide 47 is applied with a spin coater. As is the case with the photosensitive polyamide 43, the photosensitive polyamide 47 has a heat resistance of approximately 300 degrees Celsius, but any material may be used which has a heat resistance of 200 degrees Celsius or above. From above a glass mask so formed as to have an opening corresponding to the second region 32, the photosensitive polyamide 47 is exposed, developed, and then patterned. That is, the photosensitive polyamide 47 is patterned so that a pattern obtained by reversing the pattern of the photosensitive polyamide 43 remains. After the exposure, the portion of the photosensitive polyamide 47 other than its hardened portion is removed by cleaning with a solvent (see FIG. 22G). As a result, the hardened photosensitive polyamide 47 is formed in correspondence with the region where the dielectric multilayer film 45 is formed.

Next, the exposed surface of the sacrifice layer 46 is etched with an etching agent so that part of the sacrifice layer 46 remains in a pattern corresponding to the pattern of the photosensitive polyamide 47, and then is cleaned with an organic solvent (see. FIG. 22H). Through this process, the sacrifice layer 46 is so etched as to lie on the inner side of the photosensitive polyamide 47.

Then, on the glass substrate 41, anantireflection film 48 having properties shown in FIG. 13 is formed by, for example, vacuum evaporation method so as to cover the remaining sacrifice layer 47 and the remaining photosensitive polyamide 46 (see FIG. 221). The antireflection film 48 corresponds to the antireflection film 31a described above (see FIG. 1). The antireflection film 48 is formed by being heated at, for example, 200 degrees Celsius or above. As the antireflection film 48, an AR film formed of metal oxide can be used, as is the case with the dielectric multilayer film 45.

Subsequently, the remaining sacrifice layer 46, and the antireflection film 48 superimposed thereabove are etched and thereby removed (see FIG. 22J). As a result, on the glass substrate 41, the region where the dielectric multilayer film 45 is formed and the region where the antireflection film 48 is formed remain. The region where dielectric multilayer film 45 is formed, which has properties shown in FIG. 14, functions as a reflective region, thus corresponding to the second region 32 of the rising mirror 4. The region where the antireflection film 48 is formed, which has properties shown in FIG. 13, functions as a transmissive region, thus corresponding to the first region 31 of the rising mirror 4.

As described above, the dielectric multilayer film 45 and the antireflection film 48 are formed by, but not limited to, vacuum evaporation, and thus may be formed by, for example, a sputtering method or a CVD method. In the above description, the dielectric multilayer films 45 and 47 are patterned by a liftoff method, but may also be patterned by a masking method or a laser abrasion method.

To improve the light use efficiency, the antireflection film 48 having properties shown in FIG. 13 may also be formed on the rear surface of the rising mirror 4. In this case, the antireflection film 48 requires no patterning, and thus may be simply formed over the entire rear surface of the rising mirror 4.

In this embodiment, the phase adjustment layer 44 and the dielectric multilayer film 45 are first formed on the second region 32, and then the antireflection film 48 is formed on the first region 31. Alternatively, when both the dielectric multilayer film 45 and the antireflection film 48 are to be formed, the antireflection film 48 may be first formed, and then the dielectric multilayer film 45 may be formed.

(4. Effects)

As described above, a rising mirror 4 as a reflective optical element of this embodiment has on the same plane a plurality of regions (a first region 31 and a second region 32) having mutually different reflection properties, at least one of which region (for example, the second region 32 as an optical thin film) has a phase adjustment layer 33 for adjusting the phase of reflected light. The phase shift (phase delay difference) in reflected light between the first region 31 and the second region 32 can be reduced by adjusting the phase of reflected light on the second region 32 by the phase adjustment layer 33, that is, by adjusting the thickness and refractive index of the phase adjustment layer 33, thus permitting suppression of disturbance in the wave front of reflected light as a whole obtained via the plurality of regions having different reflection properties.

In this case, as in Example 1, the plurality of regions may respectively have optical thin films (for example, a dielectric multilayer film 32a and an antireflection film 31a). Forming the plurality of regions in this manner can reliably provide a plurality of regions having different reflection properties.

As in Example 2, the plurality of regions may be composed of a region having an optical thin film (for example, the second region 32 having the dielectric multilayer film 32a) and a region having no optical thin film (the first region 31). This construction can easily achieve a plurality of regions having different reflection properties and also does not require formation of an optical thin film on the first region 31; thus making it easier accordingly to provide the rising mirror 4 as a reflective optical element.

As in Examples 1 and 2, providing the phase adjustment layer 33 to the second region 32 having the dielectric multilayer film 32a permits simultaneously forming the dielectric multilayer film 32a and the phase adjustment layer 33 (see FIG. 22D), thereby making it easy to provide the rising mirror 4 as a reflective optical element.

As indicated in Examples 1 and 2, the phase adjustment layer 33 is provided as a first layer on a glass substrate 4a in the region having an optical thin film (the second region 32 having the dielectric multilayer film 32a), that is, on the most glass substrate 4a side. Providing the phase adjustment layer 33 in this manner permits the phase adjustment of reflected light with the phase adjustment layer 33 with almost no change made in the reflection properties on the optical thin film described above.

5. Variations

The above description refers to an example where the phase adjustment layer 33 is provided so as to reduce phase shift in reflected light between the plurality of regions having different reflection properties (first region 31 and second region 32). For example, the phase adjustment layer 33 may be provided, considering phase shift caused by the objective lens 7 (see FIG. 2). That is, the phase adjustment layer 33 may be so configured as to adjust the phase of reflected light on a corresponding region (the second region 32 where the phase adjustment layer 33 is provided) so that the phase shift in reflected light between the plurality of regions can cancel out the phase shift caused by the objective lens 7. This configuration permits, as is the case with Examples 1 and 2, appropriately setting the thickness and refractive index of the phase adjustment layer 33.

This configuration intentionally causes phase shift in reflected light between the plurality of regions by use of the phase adjustment layer 33 and cancels out the phase shift caused by the objective lens 7 with the phase shift occurring on the rising mirror 4, thus permitting elimination of disturbance in the wave front of light traveling from the rising mirror 4 via the objective lens 7 and finally shined on the optical disc D, whereby an optical spot of an appropriate diameter can be formed on the optical disc D.

This embodiment has been described referring to an example where a reflective optical element of the invention having a plurality of regions with different reflective properties is applied, but not limited, to the rising mirror 4 of the optical pickup. Thus, the reflective optical element of the invention is applicable not only to the rising mirror of the optical pickup as described above but also to those, for example, a bending mirror of a laser printer, which use light reflected on a plurality of regions having different reflection properties.

This embodiment has been described referring to a case where a plurality of light sources are provided. However, the rising mirror 4 (reflective optical element) of this embodiment is also applicable to an optical system having one light source.

(6. Present Invention as Defined in Different Ways)

As described above, a reflective optical element of the present invention is a reflective optical element having on the same plane (on the same substrate) a plurality of regions with different properties, at least one of which regions has a phase adjustment layer for adjusting the phase of reflected light. This permits suppressing disturbance in the wave front of reflected light as a whole obtained via the plurality of regions having different properties in the reflective optical element.

In this case, the plurality of regions of the reflective optical element may respectively have optical thin films. This permits reliably providing a plurality of regions having different reflection properties.

The plurality of regions of the reflective optical element may be a region having an optical thin film and a region having no optical thin film. This also permits providing a plurality of regions having different reflection properties, and also requires no optical film to be formed on part of the regions, thus permitting easily obtaining the reflective optical element accordingly.

It is preferable that the phase adjustment layer described above adjusts the phase of reflected light on a corresponding region (region having the phase adjustment layer) so that phase shift in reflected light between the plurality of regions becomes between −10° and 0°, inclusive, or between 0° and 10°, inclusive. When the phase shift in reflected light between the plurality of regions is within the above range, disturbance in the wave front of reflected light as a whole obtained via these regions can be reliably suppressed.

The phase adjustment layer may be designed to adjust the phase of reflected light on a corresponding region so as to eliminate phase shift in reflected light between the plurality of regions. This permits elimination of disturbance in the wave front of reflected light as a whole obtained via these regions.

It is preferable that the phase adjustment layer be provided closest to the plane described above in the region having an optical thin film. This permits the phase adjustment of reflected light on the phase adjustment layer with almost no changes made in the reflection properties of the optical thin film.

It is preferable that the plurality of regions of the reflective optical element be composed of a first region on which the central portion of a beam is made incident and a second region on which the peripheral portion of the beam is made incident and that the first region has an optical property that transmits incidence light at a predetermined transmittance.

According to this configuration, when light from a light source is made incident on a reflective optical element, the light transmitted through the first region can be used as monitored light for adjusting the amount of light from the light source. Moreover, the intensity distributions of the light reflected on the first region and the second region become such that only the central portion of an incidence beam has a lower intensity. Thus, the spot of light condensed on the optical disc via this reflective optical element can be more narrowed down, thus providing so-called super-resolution effect that can be exhibited even in high-density recording and reproduction.

The optical pickup of the present invention may include a light source that emits light, and a rising mirror that reflects the light emitted from the light source and directs the light to an optical disc. The rising mirror may be composed of a reflective optical element according to the invention. This construction permits suppressing disturbance in the wave front of light reflected on the rising mirror and shined on the optical disc.

The optical pickup of the invention may include a light source that emits light, a rising mirror that reflects the light emitted from the light source and directs the light to an optical disc, and a monitoring detector for controlling the light emitted from the light source. The rising mirror may be composed of the reflective optical element according to the invention, and the monitoring detector may be configured to detect light transmitted through the first region of the reflective optical element and control the optical output of the light source based on the detection result.

This configuration also permits suppressing disturbance in the wave front of light reflected on the rising mirror and shined on the optical disc. Moreover, this construction can provide an optical pickup in a front monitoring method and also can provide super-resolution effect that the spot of light condensed on the optical disc is narrowed down.

With this construction, it is preferable that the optical pickup of the present invention further include an objective lens that condenses on the optical dick the light reflected on the rising mirror. It is also preferable that the phase adjustment layer of the reflective optical element that composes the rising mirror be configured to adjust the phase of reflected light on a corresponding region so that phase shift caused by the objective lens can be cancelled out by phase shift in reflected light between the plurality of regions.

In this case, with the aid of phase adjustment of reflected light by the phase adjustment layer of the reflective optical element, the phase shift caused by the objective lens is cancelled out by the phase shift in reflected light between the plurality of regions, thus permitting eliminating disturbance in the wave front of light reflected on the rising mirror and shined on the optical disc via the objective lens.

Based on the description above, it is obvious that various modifications may be made to the present invention. Therefore, it should be understood that the present invention may be embodied within the scope of accompanying claims without being restricted to the detailed statements.

What is claimed is:

1. A reflective optical element, comprising a plurality
of regions formed on a same plane and having different reflection properties,
wherein at least one of the plurality of regions has a phase adjustment layer for adjusting a phase of reflected light.

2. The reflective optical element as claimed in claim 1,
wherein each of the plurality of regions has an optical thin film.

3. The reflective optical element as claimed in claim 1,
wherein the plurality of regions include a reflective region having a reflection film as an optical thin film and a transmissive region having an antireflection film as an optical thin film.

4. The reflective optical element as claimed in claim 1,
wherein the plurality of regions include a thin film formation region having the optical thin film and a thin film non-formation region having no optical thin film.

5. The reflective optical element as claimed in claim 1,
wherein the plurality of regions include a reflective region having a reflection film as an optical thin film and a transmissive region having no antireflection film as an optical thin film.

6. The reflective optical element as claimed in claim 1,
wherein the phase adjustment layer adjusts a phase of reflected light on a corresponding region so that phase shift in reflected light between the plurality of regions becomes −10 to 0° or 0° to 10°.

7. The reflective optical element as claimed in claim 1,
wherein the phase adjustment layer adjusts a phase of reflected light on a corresponding region so that phase shift in reflected light between the plurality of regions is eliminated.

8. The reflective optical element as claimed in claim 1,
wherein at least one of the plurality of regions has an optical thin film.

9. The reflective optical element as claimed in claim 8,
wherein the phase adjustment layer is provided closest to the plane in the region having the optical thin film.

10. The reflective optical element as claimed in claim 9, further comprising a substrate where the plurality of regions are formed,
wherein a difference in a reflective index is 0.07 or below between the substrate and the phase adjustment layer.

11. The reflective optical element as claimed in claim 1,
wherein the plurality of regions include: a first region on which a central portion of a beam is made incident; and a second region on which a peripheral portion of the beam is made incident, and
wherein the first region has optical properties that transmit incidence light at a predetermined transmittance.

12. An optical pickup, comprising:
a light source that emits light; and
a rising mirror that reflects the light emitted from the light source and directs the light to an optical disc,
wherein the rising mirror includes a plurality of regions formed on a same plane and having different reflection properties, and
wherein at least one of the plurality of regions has a phase adjustment layer for adjusting a phase of reflected light.

13. The optical pickup as claimed in claim 12, further comprising an objective lens that condenses on the optical disc the light reflected on the rising mirror,
wherein the phase adjustment layer adjusts a phase of reflected light on a corresponding region so that phase shift caused by the objective lens can be cancelled out by phase shift in reflected light between the plurality of regions.

14. The optical pickup as claimed in claim 12, comprising
a monitoring detector for controlling output of the light emitted from the light source,
wherein the plurality of regions include a transmissive region that transmits incidence light at a predetermined transmittance, and
wherein the monitoring detector detects the light transmitted through the transmissive region, and controls optical output of the light source based on the detection result.

15. An optical pickup, comprising:
a light source that emits light;
a rising mirror that reflects the light emitted from the light source and directs the light to an optical disc; and
a monitoring detector for controlling an output of the light emitted from the light source,
wherein the rising mirror includes a plurality of regions formed on a same plane and having different reflection properties, and
wherein at least one of the plurality of regions has a phase adjustment layer for adjusting a phase of reflected light.
wherein the plurality of regions includes: a first region on which a central portion of a beam is made incident; and a second region on which a peripheral portion of the beam is made incident,
wherein the first region has optical properties that transmit incidence light at a predetermined transmittance, and
wherein the monitoring detector detects the light transmitted through the first region of the reflective optical element, and controls optical output of the light source based on the detection result.

16. The optical pickup as claimed in claim 15, further comprising an objective lens that condenses on the optical disc the light reflected on the rising mirror,
wherein the phase adjustment layer adjusts a phase of reflected light on a corresponding region so that phase shift caused by the objective lens can be cancelled out by phase shift in reflected light between the plurality of regions.
